(19) United States
(12) Patent Application Publication
(10) Pub. No.: US 2002/0120433 A1
(43) Pub. Date: Aug. 29, 2002

(54) Computer-aided configuration tool and apparatus

(76) Inventors: Christiane Foertsch, Erlangen (DE); Toni Kress, Lauf (DE)

Correspondence Address: HARNESS, DICKEY & PIERCE, P.L.C., P.O.BOX 8910, RESTON, VA, 20195, US

(21) Appl. No.: 10/084,153

(22) Filed: Feb. 28, 2002

(30) Foreign Application Priority Data
Feb. 28, 2001 (DE) DE 10109540.6

(51) Int. Cl. G06F 9/45

(52) U.S. Cl. 703/22

(57) ABSTRACT

Technical elements, their technical relationships and technical characteristics for the elements can be preset using a computer-aided configuration tool. The elements and their relationships classify a technical system. Characteristics for an element may be preset only if, in consequence, it remains compatible with another element to which it is intended to be related. Alternatively, the characteristics of the elements and a relationship which exists between them are used to check whether they are compatible with one another.

This application hereby claims priority under 35 U.S.C. §119 on German application number DE 10109540.6 filed Feb. 28, 2001, the entire contents of which are hereby incorporated herein by reference.

### FIELD OF THE INVENTION

The present invention generally relates to a computer-aided configuration tool and apparatus.

### BACKGROUND OF THE INVENTION

Configuration processes for technical systems are becoming ever more complex. The configuration process thus requires ever greater complexity, in particular with regard to the general trend to decentralization.

### SUMMARY OF THE INVENTION

An object of an embodiment of the present invention is to provide a computer-aided configuration tool, and apparatus, via which it is possible to configure even complex technical systems, and to check a given configuration for faults, in a simple manner.

With regard to simple and fault-free configuration, the object can be achieved by a computer-aided configuration tool in which a number of technical elements and their technical relationships can be entered, such that the elements and their technical relationships specify a technical system. The technical characteristics can be preset for each element in the configuration tool. In this case, only the presetting of technical characteristics for a first element may be permissible. On the basis of this, it may remain compatible with a second element with which it is intended to be related.

For checking a given configuration, the object may be achieved by a computer-aided configuration tool into which a number of technical elements and their technical relationships can be entered, such that the elements and their relationships specify a technical system. The technical characteristics can be preset for each element in the configuration tool. The characteristics of a first and of a second element and a relationship which exists between these elements can be used to check whether the first element is compatible with the second element.

If the check relates to an existing configuration, the checking process is particularly simple if the elements, their technical characteristics and their relationships can be read from a file or a file system, in particular an ASCII file.

If the elements, their technical characteristics and their relationships can be entered and/or amended interactively, new entries and amendments can be carried out particularly easily.

If the technical characteristics for the elements are preset by selecting an element from a catalog of elements with predefined element-specific characteristics, interactive entries can be produced particularly conveniently and easily. In particular, this ensures that entries are sensible, which means that corresponding elements are, in fact, available.

If the check for compatibility includes a check of the nature of the first and of the second element, a check of the existing relationship and a check as to whether the first element satisfies a technical condition which is dependent on the nature of the second element and/or of the existing relationship, the check is particularly reliable.

If the condition can be selected from a set of conditions which are stored in a file or a file system, in particular in an ASCII file, the configuration tool operates in a particularly flexible manner. In particular, in this case, the conditions can be amended easily—namely via any conventional editor.

If the entered or amended elements whose technical characteristics and whose relationships can be stored as a file or file system, in particular once again as an ASCII file, configurations can be documented particularly easily.

The configuration tool can, in principle, be used universally. However, the elements are preferably electrical elements and the characteristics are preferably electrical, electronic or electromechanical characteristics. Examples of such elements include low-voltage switching devices and their upstream and downstream elements.

### BRIEF DESCRIPTION OF THE DRAWINGS

Further advantages and details can be found in the following description of an exemplary embodiment. In this case, illustrated in outline form:

FIG. 1 shows an example of a technical system,

FIG. 2 shows a computer, and

FIG. 3 shows a flowchart.

### DETAILED DESCRIPTION OF THE PREFERRED EMBODIMENTS

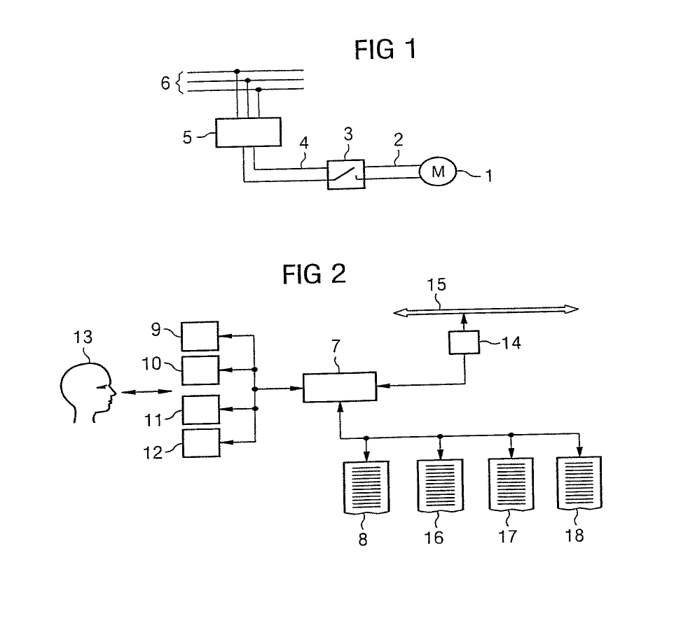

FIG. 1 shows a very simple example of a technical system. According to FIG. 1, this technical system has a motor 1, which is connected to a supply module 5 via a cable 2, a contactor 3 and a further cable 4. The supply module 5 is supplied via a through-phase network 6. The elements 1 to 5 of the technical system are thus electrical elements, namely a low-voltage switching device (contactor 3), its upstream elements (cable 4 and supply module 5), and its downstream elements (cable 2 and motor 1).

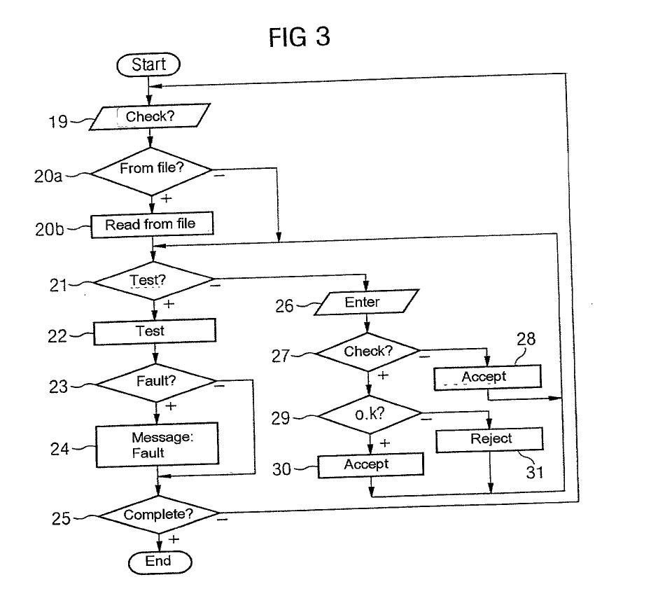

The technical system according to FIG. 1 will now be configured by using the computer 7 which, according to FIG. 2, is programmed with a configuration tool 8, which can be stored in a memory (not shown) and/or a given configuration will be checked. For this purpose, the computer 7 includes normal associated input and output units 9 to 12, for example a keyboard 9, a mouse 10 (and/or other input units), a monitor 11 and a printer 12 (and/or other output units). The computer 7 uses the units 9 to 12 to communicate with a schematically illustrated user 13. The computer 7 includes a processor (not shown) for performing necessary process steps of the method discussed in FIG. 3 in conjunction with information selected/input/specified via input devices 9, 10 based upon the tool 8 stored in memory. Furthermore, if required, the computer 7 may have an associated interface 14, via which the computer 7 is connected to a computer network 15, for example to the Internet 15. In the course of the processing by the configuration tool 8, which is a program module (which can be embodied in any computer readable medium such as a CD, ROM, etc.), the computer 7 in the process, inter alia, accesses files or file systems 16 to 18 for example (where the number of files in not limitative and where the expression files is used in the following text, for the sake of simplicity, this term should also always be understood as including the possibility of a file system). The files 16 to 18 are preferably, but not necessarily, in the form of ASCII files.

The file 16 is, for example, a file in which the elements 1 to 5, their technical characteristics and their relationships with one another can be stored. The configuration tool 8 can both read from and write to the file 16. The file 16 can thus specify the technical system. The file 17 may also contain a catalog of elements with predefined element-specific characteristics. The file 18 contains conditions against which the elements 1 to 5 can be checked.

In the above example, which is described in configuration with FIG. 1, the file 16 could, for example, have the following layout:

1: MotorType 1

MLFB

230 V AC

2 kW

2

2

.

.

.

2: Cable Type 3

MLFB

500 V

16 A

2.0

1.3

.

.

.

3: Contactor Type 2

400 V 3-phase

16 A

0.0

2.4

.

.

.

4: Cable Type 2

MLFB

500 V

16 A

0.2

3.5

.

.

.

5: Supply Module Type 9

MLFB

400 V 3-phase

30 A

2

4

.

.

.

In the above mentioned table, the numbers before the colon indicate the number of the respective element. The colon is then followed by a description of the element, a unique type designation (MLFB=machine-legible factory designation) as well as its electrical and electromechanical characteristics and its relationships with other elements, in particular its connections. This will be explained in more detail in the following text with reference to the cable 2.

According to the above table, the cable 2 is a Type 3 cable. For the purposes of an embodiment of the present invention, its MLFB is irrelevant, provided it is only unique for this cable. The maximum voltage which can be transmitted via the cable 2 is 500 volts, and the maximum current is 16 amperes. At its ends, the cable is provided with connection types “2” and “0”. “2” may, for example, symbolize a standard plug socket, and “0” may symbolize simple stripped wire ends. The cable 2 is connected directly to the elements 1 and 3. Furthermore, it may have additional characteristics ( . . . ).

The electrical characteristics of the elements 1 to 5 are, for example, their voltages, currents, powers etc. The nature of the connection technique (for example Type 2 or Type 0) is an electromechanical characteristic. However, other electronic characteristics, such as the nature of a Bus protocol or a maximum permissible data transmission rate, may also be used. The technical relationships comprise the sequence of the elements 1 to 5.

The catalog file 17 may have a similar structure to the configuration file 16. However, it does not contain the line which defines the elements to which the individual predefined elements are to be connected. Instead of this, it may contain further—technical or non-technical—characteristics of the element descriptions stored in it, for example the dimensions, the weight, the manufacture and the price of the described element.

The file 16 can be selected from the configuration tool 8, and its contents, that is to say the elements 1 to 5, their technical characteristics and their relationships, can be read. In the same way, the elements 1 to 5, their technical characteristics and their relationships are once again written to the file 16, and are thus stored in it. This is also true if the file 16 is made available externally, for example via a floppy disk drive or via the computer network 15.

However, it is also possible to enter and/or to amend the elements 1 to 5 and their technical characteristics as well as their relationships interactively. In this case, individual entries can be preset interactively. However, it is also possible to select a single element group (for example “motors”). In this case, the configuration tool 8 accesses the file 17. By presetting the criterion “motors”, a search for all motors is carried out in the catalog 17, and the motors already specified in the catalog 17 are offered to the user 13. The user 13 then just needs to select one element, in order to specify the element with all its technical characteristics. If necessary, the element group may in this case be selected in steps, until the desired element is unambiguously selected. A very simple input process is thus possible.

The confirmation tool 8 may include a plurality of segments which cause the computer to perform a series of steps based upon interactively specified descriptions of technical elements. The steps and interactively specified descriptions will be explained with regard to FIG. 3, wherein it is understood that the configuration tool 8 interacts via the computer 7, and can be stored on a computer readable medium.

The configuration tool 8 allows not only a check of an existing configuration but also—with or without a check—allows a configuration process as such. Thus, as shown in FIG. 3, during the processing of the configuration tool 8, a check is first of all carried out in a step 19 as to whether a check for compatibility should be carried out at this stage while presetting the technical characteristics. A check is then carried out in a step 20a as to whether data should be read from the file 16. Depending on the result of this input, the process continues with a step 21 either immediately or after a step 20b, in which the file 16 is read to the computer 7.

A check is carried out in step 21 to determine whether the current configuration or technical system should be tested. A question is thus asked as to whether the configuration should be checked for compatibility, irrespective of whether it is old or has been newly entered, and irrespective of whether it has been entered correctly or incorrectly.

If the result is positive, a step 22 is used to check, for each pair of elements 1 to 5, whether there is a relationship between these elements 1 to 5 and what restrictions this imposes, for example, on the compatibility of the elements 1 to 5. This check is carried out by processing the conditions stored in the file 18. The characteristics of the elements 1 to 5, any relationships existing between the elements 1 to 5, and the conditions in the file 18 are thus used for checking.

A step 23 then checks whether any incompatibility has been found. If yes, a jump is made first of all to a step 24 in which a fault message is emitted. Otherwise, a jump is made directly to a step 25. The step 25 checks whether the processing by the configuration tool 8 should be ended. If yes, the processing is ended, otherwise a jump is made back to the step 19.

If the test result in step 21 was negative, a jump is made to a step 26 where the configuration tool 8 interactively checks an input or preset.

The input may be, for example, a new entry or the deletion of an element. The input may also be the presetting of a characteristic, for example the rating of the motor 1.

In the case of a single input of a technical characteristic, for example of a rating, this is initially accepted only provisionally. A check is then carried out in a step 27 to determine whether an immediate check of inputs was requested in the step 19. If not, the input is finally accepted irrespective of whether it is or is not compatible with previous inputs. Otherwise, a check is carried out in a step 29 to determine whether the input is compatible with previous inputs. If it is compatible, it is accepted in a step 30, otherwise it is rejected in a step 31.

However, if required, in step 26, the user can also make an entry in a first step element that, for example, he wishes to specify a motor. In this case, the configuration tool 8 accesses the catalog file 17, and offers motors for selection to the user 13. If an immediate check of compatibility has been entered in step 19, only one choice of possible motors is offered. In this case the choice may, for example, comprise elements which can actually be selected and are displayed prominently, and the elements which cannot be selected are displayed shaded gray.

In the last-mentioned case, the compatibility check is carried out even before final selection of the relevant element. However, in both cases, the only technical characteristics which may be preset are those on the basis of which the relevant specified element, for example the motor 1, remains compatible with the other elements, for example 2 to 5.

One technical condition for a newly specified element is, for example, that its connection technique must be compatible with that of the already specified element to which it is intended to be directly connected. The compatibility can be checked on the basis of the specification of the individual items 1 to 5 (see the table above). In this case, as stated above, the check can optionally be carried out during the test (in step 22) or else even while presetting a new characteristic (check in step 29, or during the input in step 26). The difference between the two procedures is essentially only that, in the first-mentioned case, both elements are already specified, and the configuration tool 8 therefore does not know which was specified first. It can thus only indicate that there is an incompatibility. On the other hand, in the second case, the incompatibility has arisen as a result of the presetting of a new technical characteristic for one of the elements. In this case, the user 13 can be immediately informed that this characteristic will lead to an incompatibility with a second element with which this element is intended to be related. If required, display emphasis can even be used such that only compatible elements can be selected from the catalog file 17.

In order to test for compatibility, the types of elements are recorded first of all and, if necessary, are compared with one another. For example, the contactor 3 normally has to be connected to two cables (in this case cables 2 and 4). Furthermore, a check is carried out of the relationship between the elements, and what condition results from this. Relationships between elements are, for example, an immediate predecessor or successor, or a non-immediate predecessor or successor. Further checks include, for example, whether the stated cable cross section of one of the cables 2, 4 is sufficient to carry the required power to the motor 1. Furthermore, for example, it is possible to check whether the contactor 3 has the required current-carrying capacity, or whether the supply module 5 can emit the required voltage and the required power.

In general, the preconditions for an individual check are that the first element is of a first type and the second element is of a second type, that there is a predetermined relationship between the two elements, and that a characteristic of the one element satisfies a specific condition. If these preconditions are met, either the other element or else the first-mentioned element must also satisfy a second condition. Otherwise, there will be an incompatibility.

The conditions can be implemented in the configuration tool 8 itself. However, preferably, they are stored in the condition file 18—likewise using the ASCII format once again. Overall, the conditions stored there form a set of conditions which could easily be amended by means of any editor, on the basis of the memory format (ASCII) of the condition file 18.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A computer-aided configuration tool, into which a number of technical elements and their technical relationships can be entered, such that the elements and their relationships specify a technical system, comprising:
technical characteristics which can be set for each element in the configuration tool, wherein only the setting of technical characteristics for a first element is permissible, on the basis of which it remains compatible with a second element with which it is intended to be related.

2. A computer-aided configuration tool, into which a number of technical elements and their technical relationships can be entered, such that the elements and their relationships specify a technical system, comprising:
technical characteristics which can be set for each element in the configuration tool, wherein the characteristics of a first and of a second element and a relationship which exists between these elements, are used to check whether the first element is compatible with the second element.

3. The configuration tool as claimed in claim 2, wherein the elements, their technical characteristics and their relationships are read from at least one of a file and a file system.

4. The configuration tool of claim 3, wherein the file is an ASCII file.

5. The configuration tool as claimed in claim 1, wherein the elements, their technical characteristics and their relationships are at least one of interactively enterable and amendable.

6. The configuration tool as claimed in claim 2, wherein the elements, their technical characteristics and their relationships are at least one of interactively enterable and amendable.

7. The configuration tool as claimed in claim 3, wherein the elements, their technical characteristics and their relationships are at least one of interactively enterable and amendable.

8. The configuration tool as claimed in claim 5, wherein the technical characteristics for the elements are set by selecting one element from a catalog of elements with defined element-specific characteristics.

9. The configuration tool as claimed in claim 1, wherein the check for compatibility includes a check of the nature of the first and of the second element, a check of the existing relationship and a check as to whether the first element satisfies a technical condition which is dependent on at least one of the nature of the second element and of the existing relationship.

10. The configuration tool as claimed in claim 9, wherein the condition can be selected from a set of conditions which are stored in at least one of a file and a file system.

11. The configuration too of claim 10, wherein the file is an ASCII file.

12. The configuration tool as claimed in claim 2, wherein the check for compatibility includes a check of the nature of the first and of the second element, a check of the existing relationship and a check as to whether the first element satisfies a technical condition which is dependent on at least one of the nature of the second element and of the existing relationship.

13. The configuration tool as claimed in claim 12, wherein the condition can be selected from a set of conditions which are stored in at least one of a file and a file system.

14. The configuration tool of claim 13, wherein the file is an ASCII file.

15. The configuration tool as claimed in claim 5, wherein the entered or amended elements, their technical characteristics and their relationships can be stored as at least one of a file and a file system.

16. The configuration tool of claim 15, wherein the file is an ASCII file.

17. The configuration tool as claimed in claim 1, wherein the elements are electrical elements, and the characteristics are at least one of electrical, electronic and electromechanical characteristics.

18. The configuration tool as claimed in claim 2, wherein the elements are electrical elements, and the characteristics are at least one of electrical, electronic and electromechanical characteristics.

19. The configuration tool as claimed in claim 17, wherein the elements are low voltage switching devices and their upstream and downstream elements.

20. The configuration tool as claimed in claim 18, wherein the elements are low voltage switching devices and their upstream and downstream elements.

21. The configuration tool of claim 1, embodied in a memory.

22. The configuration tool of claim 1, embodied in a computer readable medium.

23. The configuration tool of claim 2, embodied in a memory.

24. The configuration tool of claim 2, embodied in a computer readable medium.

25. An apparatus comprising:
a memory for storing a computer aided configuration tool including technical characteristics which can be set for each element in the configuration tool, wherein only the setting of technical characteristics for a first element is permissible, on the basis of which it remains compatible with a second element with which it is intended to be related; and
input means for permitting at least one of entry and change of at least one of an element, a technical characteristic, and element relationships.

26. An apparatus comprising:
a memory for storing a computer aided configuration tool including technical characteristics which can be set for each element in the configuration tool, wherein the characteristics of a first and of a second element and a relationship which exists between these elements, are used to check whether the first element is compatible with the second element; and
input means for permitting at least one of entry and change of at least one of an element, a technical characteristic, and element relationships.
